(19) United States
(12) Patent Application Publication
(10) Pub. No.: US 2004/0156997 A1
(43) Pub. Date: Aug. 12, 2004

(54) Electrically conductive floor coating, process for producing the floor coating, coating formulation, and method for protecting structures using the floor coating

(76) Inventors: Thomas Burkhart, Montabaur (DE); Thorsten Landau, Ibbenburen (DE)

Correspondence Address: LERNER AND GREENBERG, P.A., POST OFFICE BOX 2480, HOLLYWOOD, FL, 33022-2480, US

(21) Appl. No.: 10/753,230

(22) Filed: Jan. 7, 2004

(30) Foreign Application Priority Data
Jan. 7, 2003 (DE) 103 00 459.9

(51) Int. Cl. B05D 3/02

(52) U.S. Cl. 427/402; 427/372.2

(57) ABSTRACT

A floor coating includes an electrically conductive priming layer and an electrically conductive top layer that is impermeable to water. Processes for producing the floor coatings and suitable coating formulations are described.

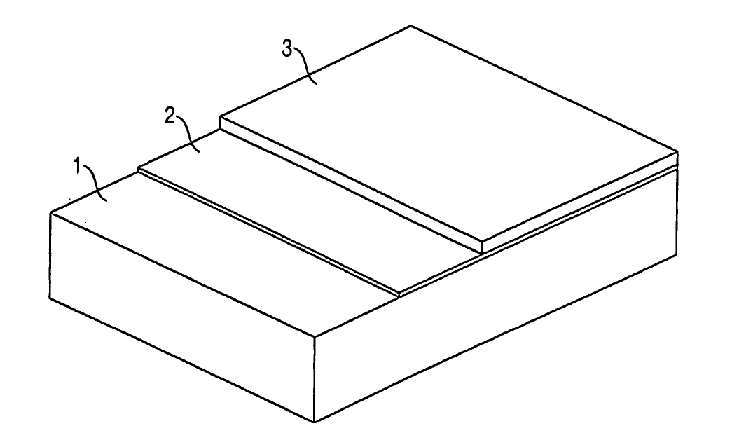

### BACKGROUND OF THE INVENTION

1. Field of the Invention

The invention relates to electrically conductive floor coatings based in particular on epoxy resins and composed of a priming layer and an electrically conductive top layer impermeable to liquid, a process for producing the floor coating, a coating formulation, and a method for protecting structures using the floor coating.

For industrial floors in buildings used to store liquids that represent an environmental hazard a special floor coating is required that prevents the leakage of such liquids to the subsoil even in the event of cracks forming. These floors are required to meet the provisions of the German Federal Water Act (WHIG, particularly § 19h). Floors of this kind and the coatings used for them are also referred to in Germany, accordingly, as WHIG floors or WHIG floor coatings.

In accordance with the mechanical and chemical requirements of the stipulations of the WHIG, the floor coatings used to date have included a priming layer, an electrically conductive interlayer, and an electrically conductive top layer impermeable to liquid. Variation of this three-layer construction is also possible such that instead of the conductive interlayer a conductive, extensible base layer is used. This base layer is generally a floating layer of synthetic resin compound, especially epoxy resins or vinyl ester resins, into which a reinforcement is embedded. This reinforcement is configured as a honeycomb or lattice ply of glass, metal, paper board, or synthetic resin, especially polyester. The most commonly used reinforcements are of glass fiber mats, woven and/or nonwoven, with a “basis weight” (mass per unit area, mass coverage) of from 200to 460 g/m², in particular from 300 to 450 g/m². Electrical conductivity is produced by using carbon fiber webs with a mass per unit area of from 20 to 30 g/m², which are laminated on last after the mats have been embedded. Subsequently the top layer can be applied.

The coatings are produced by applying coating formulations including binders, fillers, and, optionally, additives to the target surfaces and curing them thereon. The binders in the respective coating formulations are composed in virtually all cases of cold-curing mixtures of synthetic resins, especially epoxy resins, and aminic hardeners.

Besides the particular epoxy resins and the corresponding hardeners, the coating formulations further include fillers and additives for the purposes, inter alia, of deaeration, wetting, and improvement of leveling.

The aminic hardeners are amino-terminal adducts of epoxide compounds and amines. The epoxide compounds used include primarily diepoxides based on bisphenol A and/or bisphenol F, with, as the amine component, aliphatic, cycloaliphatic or aromatic-aliphatic amines or mixtures thereof, especially isophoronediamine and m-xylylenediamine. These adduct hardeners, as they are known, normally include, in addition to benzyl alcohol, further modifiers and accelerators.

The epoxy resin formulations thus obtained are applied as self-leveling floor coatings in layer thicknesses of up to 3 mm. The desired electrical conductivity is achieved through the addition to the epoxy resin formulation of conductive fillers such as carbon black, graphite, metal powder or carbon fibers.

Applying these three-layer coatings is labor-intensive and involves long times during which the floors being coated cannot be accessed.

### SUMMARY OF THE INVENTION

It is accordingly an object of the invention to provide an electrically conductive floor coating, a process for producing the floor coating, coating formulation, and a method for protecting structures using the floor coating that overcomes the hereinafore-mentioned disadvantages of the heretofore-known devices of this general type and that provide coating systems that, without adverse effect on the requisite properties, can be applied in a smaller number of component operations, i.e., in a shorter time.

With the foregoing and other objects in view, there is provided, in accordance with the invention, a floor coating including an electrically conductive priming layer and an electrically conductive top layer. The electrically conductive top layer is disposed on the electrically conductive priming layer. The electrically conductive top layer is impermeable to liquid.

In other words, this object is achieved by using conductive coating systems in which the function of the priming layer and of the conductivity layer are combined in one layer. Thus, it is possible to produce conductive WHIG floor coatings that now require just a two-layer construction rather than a three-layer construction.

Surprisingly, it has been found that a priming layer formulated for conductivity is able to replace the existing combination of conductive interlayer and priming layer.

The invention accordingly provides floor coatings including an electrically conductive priming layer and an electrically conductive top layer that is impermeable to liquid.

A layer is considered electrically conductive for the purposes of the present invention if its leakage resistance in accordance with DIN 53482 and DIN 51953 is less than 109 ohm, for explosive liquids in particular less than 10⁶ ohm.

With the objects of the invention in view, there is also provided a process for producing a floor coating. The process includes initially applying a coating formulation of an electrically conductive priming layer to a floor. The subsequent step is applying a coating formulation of an electrically conductive top layer to the floor. The next step is curing the electrically conductive priming layer and the electrically conductive top layer to produce the floor coating as described previously.

In accordance with a further object of the invention, the process can include, after the curing of the top layer, applying a surface coating formulation of the conductive priming layer. The next step is strewing silicon carbide in powder form over the surface coating formulation. The next step is curing the surface coating formulation of the top layer and then removing excess of the silicon carbide powder by vacuuming. The last step includes sealing the surface coating formulation by rolling the surface coating formulation to produce an antislip layer. The surface coating formulation for roller sealing can be electrically conductive.

With the objects of the invention in view, there is also provided a coating formulation for making the floor coating described previously. The coating formulation includes a priming-layer coating formulation for an electrically conductive priming layer. The coating formulation further includes a top-layer coating formulation for an electrically conductive top layer to be disposed on the electrically conductive priming layer. The coating formulation includes epoxy resins in the priming-layer coating formulation and/or the top-layer coating formulation. In addition, the epoxy resins can include an aqueous epoxy dispersion in the primary-layer coating formulation.

With the objects of the invention in view, there is also provided a method of protecting structures that includes applying a floor coating according to claim 1 to a floor of the production plant.

Other features that are considered as characteristic for the invention are set forth in the appended claims.

Although the invention is illustrated and described herein as embodied in an electrically conductive floor coating, a process for producing the floor coating, a coating formulation, and a method for protecting structures using the floor coating, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE is a diagrammatic top perspective view showing the layers of the coating system according to the invention.

### DESCRIPTION OF THE PREFERRED EMBODIMENTS

Referring now to the single FIGURE of the drawing, the structure of the coating system of the invention is shown on a substrate 1. The substrate 1 is only partly covered with the conductive priming layer 2 for greater ease of appreciation in the FIGURE. The conductive priming layer 2 is likewise only shown as being partly coated with the top layer 3.

The top layer 3 is additionally crack-bridging in the case of WHIG coatings. For coatings not required to satisfy the provisions of the WHIG, a two-layer conductive floor coating structure (priming layer/top layer) is sufficient, and in this case the top layer 3 need not be crack-bridging.

Layers referred to as being “crack-bridging” are those that do not themselves display any cracks when the layer below them exhibits a crack having a width of typically 0.1 to 0.5 mm and at most 2 mm.

The conductive priming layer 2 can in principle be applied to any solid substrate 1; particularly suitable in the context of the requirements of the WHIG are concrete, concrete asphalt, and screed.

Applied to the conductive priming layer 2, or inserted between it and the substrate 1, for the purposes of improved transverse conductivity, are usually one or more readily electrically conducting lead strips, fiber strands, foils, or wires made of metal, which are adhesively bonded on advantageously at a distance of a few meters (1 to 10 m), usually in square formation, or are conductively troweled and connected with one another in an electrically conducting manner. A main lead is connected to zero potential via the electrical ground line.

The invention further provides processes for producing the floor coatings of the invention and also coating formulations that can be used to produce the coatings of the invention.

In the process for producing floor coatings a coating formulation for an electrically conductive priming layer 2 and a coating formulation for an electrically conductive top layer 3 that is impermeable to liquid are applied in succession to a floor 1 and cured.

The coating formulation for the conductive priming layer 2 is normally composed of a binder, with or without solvent, and conductive fillers. This coating formulation for the conductive priming layer 2 is preferably distributed uniformly over the whole area to be coated. Advantageous layer thicknesses are in the range from 0.05 to 0.5 mm and in particular between 0.1 and 0.3 mm. Preference is given here to using the following mass fractions: from 5 to 80%, preferably from 20 to 70%, of binder, from 1 to 50%, preferably from 5 to 30%, of hardener, from 0 to 25%, preferably from 1 to 23%, of solvent, and from 0.3 to 30%, preferably from 5 to 28%, of conductive filler. A suitable composition for the coating formulation for the primer layer 2 contains for example the following mass fractions of the components:

Liquid epoxy resin* 40%

Amine hardener# 24%

Ethanol 13%

Amorphous natural graphite+ 23%

* epoxy resin based on bisphenol A, epoxide group content 5.26 mol/kg, “epoxide equivalent” 190 g/mol

# epoxide-amine adduct having an amine number of 115 mg/g (according to DIN 53176 the ratio of the mass m_{KOH} of potassium hydroxide whose neutralization consumes precisely the same amount of acid as a sample under analysis to the mass m_{B} of the sample (mass of the solid in the sample in the case of solutions or dispersions); its customary unit is “mg/g”)

+ particle size 32 to 75 μm

Suitable binders for realizing an electrically conductive priming layer 2 include epoxy resins and also aqueous dispersions of epoxy resins containing up to 30% water, in particular 10-20%, based on the mass of the overall formulation (resin and hardener). Particularly suitable epoxy resin dispersions are cationic epoxy resin dispersions, which are used simultaneously as hardeners for epoxy resins of type A. Additionally suitable are emulsions of epoxy resins.

After the priming layer 2 has been dried or cured the invention provides for the coating formulation for the conductive top layer 3 to be applied to it, preferably in a layer thickness of between 0.2 and 5 mm, with particular advantage in a thickness of between 1 and 2 mm. This is done, for example, by using a tool selected from the following: trowel, float, dropper, spreader, comb, or spray gun.

If desired, after the conductive top layer 3 has cured a slip preventative can be applied, by applying the coating formulation already used for the conductive priming layer 2 to the conductive top layer 3 by using a roller, brush, or spreader and before it cures strewing it with silicon carbide powder, generally with a particle size of between 0.1 and 5 mm, preferably from 0.2 to 2 mm. After curing, the excess particles are swept off or vacuumed off and the layer is again sealed with a coating formulation, preferably the top layer material, by rolling. Preference is given to using a coating formulation that corresponds to the formulation for the top layer 3 that has likewise been modified for electrical conductivity.

The coating formulations for top layer 3 and priming layer 2 of the floor coating of the invention are preferably both based on epoxy resins. For both layers it is preferred to employ the materials set out below.

The preferred material for the electrically conductive top layer 3 is an epoxy resin formulation including an epoxy resin (A), hardener (B), and additives conventional for floor coatings, such as fillers, dyes, pigments, devolatilizers, defoamers, and leveling agents.

Suitable epoxy resin components (A) include a multiplicity of the compounds known for this purpose, containing on average more than one epoxide group, preferably two epoxide groups, per molecule. It is also possible, however, to use mixtures of polyepoxides with monoepoxides. These epoxide compounds (epoxy resins) can be either saturated or unsaturated and can be aliphatic, cycloaliphatic, aromatic, or heterocyclic and may also contain hydroxyl groups. They may additionally contain substituents which do not give rise to disruptive secondary reactions under the conditions of mixing or of reaction, such as alkyl or aryl substituents, ether groups and the like. The epoxide compounds (A) preferably have specific epoxide group contents of from 2 to 10 mol/kg (“epoxide equivalent weights” of from 100 to 500 g/mol).

They preferably include glycidyl ethers (A10) of polyhydric phenols, especially bisphenols, and also novolaks whose specific epoxide group contents are from 2 to 10 mol/kg, preferably from 4 to 6.7 mol/kg (“epoxide equivalent weights” of from 100 to 500 but in particular from 150 to 250 g/mol). Examples of polyhydric phenols include the following: resorcinol, hydroquinone, 2,2-bis(4-hydroxyphenyl)propane (bisphenol A), isomer mixtures of dihydroxydiphenyl-methane (bisphenol F), 4,4′dihydroxydiphenylcyclo-hexane, 4,4′dihydroxy-3,3′-dimethyldiphenylpropane, 4,4′-dihydroxybiphenyl, 4,4′-dihydroxybenzophenone, 1,1-bis(4-hydroxyphenyl)ethane, 1,1-bis(4-hydroxy-phenyl)isobutane, 2,2-bis(4-hydroxy-3-tert-butyl-phenyl)propane, bis(2-hydroxynaphthyl)methane, 1,5-di-hydroxynaphthalene, tris(4-hydroxyphenyl)methane, bis(4-hydroxyphenyl) ether, bis(4-hydroxyphenyl) sulfone etc. and also the chlorination and bromination products of the aforementioned compounds, such as tetrabromobisphenol A, for example. Especial preference is given to liquid diglycidyl ethers based on bisphenol A and on bisphenol F and having a specific epoxide group content of from 5.0 to 5.6 mol/kg (“epoxide equivalent weight” of from 180 to 200 g/mol).

It is also possible to use polyglycidyl ethers (A11) of polyalcohols, such as 1,2-ethanediol diglycidyl ether, 1,2-propanediol diglycidyl ether, 1,3-propanediol diglycidyl ether, 1,4-butanediol diglycidyl ether, 1,5-pentanediol diglycidyl ether, neopentyl glycol diglycidyl ether, 1,6-hexanediol diglycidyl ether, diethylene glycol diglycidyl ether, dipropylene glycol diglycidyl ether, higher polyoxyalkylene glycol diglycidyl ethers, such as higher polyoxyethylene glycol diglycidyl ethers and polyoxypropylene glycol diglycidyl ethers, mixed poly(oxyethylene-oxypropylene) glycol diglycidyl ethers, polyoxytetramethylene glycol diglycidyl ethers, polyglycidyl ethers of glycerol, of 1,2,6-hexanetriol, trimethylolpropane, trimethylol-ethane, pentaerythritol and sorbitol, polyglycidyl ethers of oxalkylated polyols (such as of glycerol, trimethylolpropane, and pentaerythritol), diglycidyl ethers of cyclohexanedimethanol, of bis(4-hydroxycyclo-hexyl)methane and of 2,2-bis(4-hydroxycyclohexyl)-propane, polyglycidyl ethers of castor oil, and triglycidyl tris(2-hydroxyethyl)isocyanurate. Especial preference is given to using polyoxyalkylene glycol diglycidyl ethers, and among them to polyoxypropylene glycol diglycidyl ethers, having a specific epoxide group content of from 1.25 to 6.7, in particular from 2.5 to 3.4 mol/kg (“epoxide equivalent weight” of from 150 to 800 and in particular from 300 to 400 g/mol).

The specific epoxide group content is the ratio of the molar amount (amount of substance) of epoxide groups, n_{(EP)} to the mass m of the epoxide in question.

In particular cases it is possible in addition to the phenolic polyglycidyl ethers (A10) or to the alcohol-derived polyglycidyl ethers (A11) to use small amounts of reactive diluents (monoepoxides) (A2) in a mass ratio of up to 30%, preferably from 10 to 20%, based on the mass of polyglycidyl ethers. Examples of suitable compounds are methyl glycidyl ether, butyl glycidyl ether, allyl glycidyl ether, ethylhexyl glycidyl ether, long-chain aliphatic glycidyl ethers, such as cetyl glycidyl ether and stearyl glycidyl ether, monoglycidyl ethers of a higher isomeric alcohol mixture, glycidyl ethers of a mixture of C₁₂ to C₁₃ alcohols, phenyl glycidyl ether, cresyl glycidyl ether, p-tert-butyl-phenyl glycidyl ether, p-octylphenyl glycidyl ether, p-phenylphenyl glycidyl ether, glycidyl ethers of an oxalkylated lauryl alcohol, and also monoepoxides such as epoxidized monounsaturated hydrocarbons (butylene oxide, cyclohexene oxide and styrene oxide), and halogenated epoxides, such as epichlorohydrin.

As epoxy resins, it is additionally possible to use poly(N-glycidyl) compounds (A12) obtainable by dehydrohalogenating the reaction products of epichlorohydrin and amines such as aniline, n-butyl-amine, bis(4-aminophenyl)methane, m-xylylenediamine or bis(4-methylaminophenyl)methane. The poly(N-glycidyl) compounds also include, however, triglycidyl isocyanurate, triglycidyl urazole and oligomers thereof, N,N′-diglycidyl derivatives of cycloalkylene-ureas, and diglycidyl derivatives of hydantoins, etc.

It is additionally possible to use polyglycidyl esters (A13) of polycarboxylic acids obtained by reacting epichlorohydrin or similar epoxy compounds with an aliphatic, cycloaliphatic or aromatic polycarboxylic acid, such as oxalic acid, succinic acid, adipic acid, glutaric acid, phthalic acid, terephthalic acid, tetrahydrophthalic acid, hexahydrophthalic acid, 2,6-naphthalenedicarboxylic acid, and higher dicarboxylic acid diglycidyl esters, such as dimerized or trimerized linolenic acid, for example. Examples are diglycidyl adipate, diglycidyl phthalate, and diglycidyl hexahydrophthalate. Mention may additionally be made of glycidyl esters of unsaturated carboxylic acids and epoxidized esters of unsaturated alcohols and unsaturated carboxylic acids, respectively.

Particular preference is given to epoxy resins (A) selected from liquid diglycidyl ethers based on bisphenol A and bisphenol F.

A detailed listing of suitable epoxide compounds can be found in the handbook “Epoxidverbindungen und Epoxidharze” by A.M. Paquin, Springer Verlag, Berlin 1958, Chapter IV, and in Lee and Neville, “Handbook of Epoxy Resins”, 1967, Chapter 2.

As epoxy hardener component (B) it is possible, for a two-component epoxy resin, to use all known amine curatives for 1,2-epoxides. The following may be mentioned by way of example: aliphatic amines (B1), such as the polyalkylenepolyamines diethylenetriamine and triethylenetetramine, tetraethylenepentamine, pentaethylenehexamine, 2,2,4- and/or 2,4,4-trimethyl-hexamethylenediamine, N,N-bis(3-aminopropyl)ethylene-diamine, 2-methylpentanediamine (DYTEK A®), oxyalkylene-polyamines such as polyoxypropylenedi- and -triamines and 1,13-diamino-4,7,10-trioxatridecane, cycloaliphatic amines (B2), such as isophoronediamine (3,5,5-tri-methyl-3-aminomethylcyclohexylamine), 4,4′-diamino-dicyclohexylmethane, 3,3′-dimethyl-4,4′-diamino-dicyclohexylmethane, N-cyclohexyl-1,3-propanediamine, diaminocyclohexanes, especially 1,2-diaminocyclohexane, 1,4-diamino-3,6-diethylcyclohexane, 1,2-diamino-4-ethylcyclohexane, 1-cyclohexyl-3,4-diaminocyclohexane, 2,2-bis(4-aminocyclohexyl)propane, 1,3-and 1,4-bis(aminomethyl)cyclohexane, piperazine, N-aminoethyl-piperazine, TCD diamine (i.e., 3(4),8(9)-bis(amino-methyl)tricyclo[5.2.1.0^{2,6}]decane), araliphatic amines (B3), such as xylylenediamines (m- and p-xylylene-diamine), and aromatic amines (B4) such as phenylene-diamines, 4,4′-oxydianiline and 4,4′-diaminodiphenyl-methane.

It is possible with preference to use mixtures of these amines as well, suitability being possessed likewise by mixtures of these amines with phenylalkanols such as, for example, benzyl alcohol, phenylethanol, 3-phenyl-propanol, and also phenoxyalkanols such as 2-phenoxy-ethanol and 2- and 3-phenoxypropanol; mixtures with benzyl alcohol are particularly preferred.

Further suitable compounds include adduct hardeners (B5) which are reaction products of epoxide compounds, especially glycidyl ethers of bisphenol A and F, with excess amines, examples being reaction products of ethylenediamine, 2,2,4-and 2,4,4-trimethylhexa-methylenediamine, isophoronediamine, 1,2-diaminocyclo-hexane, m-xylylenediamine and/or bis(aminomethyl)-cyclohexane with terminal epoxides, such as 1,2-propylene oxide or 1,2-hexene oxide, or with glycidyl ethers such as phenyl glycidyl ether, ethylhexyl glycidyl ether or butyl glycidyl ether, or with glycidyl esters, such as CARDURA E®, or with polyglycidyl ethers and/or polyglycidyl esters, as described in connection with (A10), (A11), and (A13).

The hardener (B5) is preferably an epoxide-amine adduct formed from one or more aliphatic and/or cycloaliphatic polyamines and one or more epoxide compounds having from 1 to 4 epoxide groups per molecule, the amount of the epoxide compounds for preparing the adduct being chosen such that the reaction mixture for its preparation contains from 1 to 2 mol of epoxide groups per mole of the amine.

Polyamidoamine (B6) and polyimidazoline (B7) hardeners that can be used for present purposes are prepared by condensing polyamines with carboxylic acids, with or without the addition of monocarboxylic acids; in particular, by condensing polyalkylenepolyamines with polymeric fatty acids obtained by catalytic polymerization of mono- or polyunsaturated fatty acids or by copolymerization of these fatty acids with polymerizable compounds, such as styrene, for example.

Mannich bases (B8) suitable as hardeners are prepared by condensing (primary) polyamines having preferably two primary amino groups attached to aliphatic carbon atoms, preferably diethylenetriamine, triethylene-tetramine, isophoronediamine, 2,2,4- and/or 2,4,4-tri-methylhexamethylenediamine, 1,3- and 1,4-bis(amino-methyl)cyclohexane, especially m- and p-xylylene-diamine, with aldehydes, preferably formaldehyde and monohydric or polyhydric phenols having at least one aldehyde-reactive ring position, examples being the various cresols and xylenols, p-tert-butylphenol, resorcinol, 4,4′-dihydroxydiphenylmethane, and 2,2-bis-(4-hydroxyphenyl)propane, but preferably phenol.

Particularly preferred curatives are hardeners based on TCD diamine, Mannich bases based for example on phenol and/or resorcinol, formaldehyde and m-xylylenediamine, and also N-aminoethylpiperazine and blends of N-amino-ethylpiperazine with nonylphenol and/or benzyl alcohol.

Further preferred hardeners (B) are amine-terminated liquid polymers based on butadiene or amine-terminated liquid acrylonitrile/butadiene copolymers.

The coatings of the invention are formulated preferably as two-component systems, with the additives usually added to the epoxy resin components (A), and the mixtures of (A) and the additives and auxiliaries (C) mixed with the hardeners (B) not until immediately prior to application.

The epoxy resin formulation includes further customary additives as well as the epoxy resins (A), examples being accelerators or curing catalysts (C4), further hardeners (C2) and additional curable resins or extender resins (C3), such as hydrocarbon resins, polyurethane resins, phenoxy resins and liquid polymers based on butadiene, liquid acrylonitrile-butadiene copolymers, and mixtures of the resins, and also the customary coatings additives (C1) such as pigments, pigment pastes, dyes, antioxidants, stabilizers, leveling agents and/or thickeners (thixotropic agents), defoamers and/or wetting agents, fillers, plasticizers or flame retardants. These additives can be added to the curable mixtures, where appropriate, a relatively long time before or not until immediately prior to use.

As accelerators (C4) particularly for curing with amine curatives it is possible to make use, for example, of benzyl alcohol, phenols, and alkylphenols having 1 to 12 carbon atoms in the alkyl group, cresol, the various xylenols, nonylphenol, polyphenols such as bisphenol A and F, hydroxyl-containing aromatic carboxylic acids such as salicylic acid, m-hydroxybenzoic acid, and p-hydroxybenzoic acid, and also tertiary amines, such as benzyldimethylamine and 1,3,5-tris(dimethylamino)-phenol, mixtures of N-aminoethylpiperazine and alkanol-amines (as described in German Patent Application No. DE 2 941 727 A1), ACCELERATOR 399® (Texaco Chemical Company), and the like. Accelerators may also be constituents of the hardener component (B).

Examples of additional curable resins (C3) include hydrocarbon resins, phenoxy resins, phenolic resins, polyurethane resins, polysulfides (THIOKOL®), reactive, liquid polymers of butadiene and/or corresponding acrylonitrile/butadiene copolymers (HYCAR® grades), whereas customary extender resins which may be mentioned here include, among others, nonreactive epoxy resin modifiers, such as “pine oil” (crude turpentine obtained from coniferous woods such as scotch pines, firs or stone pines by dry distillation), tars, phthalates, and coumarone oils. These resins and modifiers can be added individually or in mixtures.

The additives (C1) specified below are commonly added:

As leveling agents (C10) and/or devolatalizers/defoamers (C11) it is possible to use, for example, acetals, such as polyvinylformal, polyvinylacetal, polyvinylbutyral, polyvinylacetobutyral, polyethylene glycols and polypropylene glycols, silicone resins, mixtures of zinc soaps, of fatty acids, and aromatic carboxylic acids, particularly commercially customary products based on polyacrylates. The leveling agents can also be added to component (A) in mass fractions of from 0.1 to 4%, preferably from 0.2 to 2%, based on the overall mass.

As adhesion promoters and hydrophobicizers (C12) it is possible to make use, for example, of silanes. These may react both with the inorganic substrate and with the organic polymers or fillers present therein to form chemical bonds.

The improved adhesion may result in improvements in the mechanical values, particularly following moisture exposure. Corresponding products are offered, for example, under the name DYNASYLAN® by Huls AG or as SILAN® by Degussa AG.

Stabilizers (C13) are, for example, aromatic diketones such as benzoin which suppress local decomposition and so reduce or prevent the formation of pores. These stabilizers are used generally in mass fractions of from 0.1 to 3%, preferably from 0.2 to 2%, based on the mass of the overall binder (components (A) and (B)).

The dyes and pigments (C14) that are added may be both organic and inorganic in nature. Examples that may be mentioned include titanium dioxide, zinc oxide, and RAL color pigments.

Examples of suitable fillers (C15) include quartz flour, silicates, chalk, gypsum, kaolin, mica, barite, organic fillers such as polyamide powders, organic and inorganic fibers, and the like.

As thixotropic agents and thickeners (C16) it is possible for example to use AEROSIL® (highly disperse silica, e.g., grades 150, 200, R 202, and R 805 from Degussa) or bentonite grades (e.g., SYLODEX® 24 from Grace or BENTONE® from NL Chemicals).

Electrically conductive fillers (C17) added to the epoxy resin formulation include carbon blacks, graphites, metal powders, or carbon fibers (based on polyacrylonitrile fibers or pitch fibers; also graphite fibers). The average length of the carbon fibers is normally situated in the range from 50 to 3,000 μm. Average fiber lengths of more than 500 μm are particularly suitable. The mass fraction of the carbon fibers in the additives (C1) is with particular advantage from 0.2 to 4%, in particular between 0.5 and 2%. To produce conductive floor coatings carbon fibers should be added in amounts such that the cured coating has a surface resistance (measured in accordance with DIN 53482) of from 10³ to 10⁹ ohm and/or a leakage resistance (measured in accordance with DIN 51953) of from 10³ to 10⁹ ohm.

The epoxy resin formulation may further include one or more solvents (C18), whose mass fraction in the formulation is usually between 0.1 and 20%. Suitable solvents include monohydric alcohols, such as ethanol, ether alcohols such as butyl glycol, for example, or else aromatics (xylene, toluene) and also mineral spirits.

To produce the curable mixtures of the invention the epoxy resin components (A) are mixed together with the stated additives and fillers using appropriate equipment (dissolvers, stirrers, kneading apparatus, rollers). Components of low viscosity can be mixed as they are. It may be necessary to prevent premature reaction of the components by cooling the formulated resin system.

Both components, epoxy resin formulation (mixture of constituents A and C) and amine hardener (component B), are stored separately; the mixture is prepared shortly before use by mixing of the two components. The amounts of the two components are chosen so that the hardener amount (amount of amino groups in B) corresponds stoichiometrically to the amount of epoxide groups in the epoxy resin formulations.

After the mixing of these two components the mixture, depending on formulation, has a working time of from 0.25 to 2 hours and then cures at room temperature within a day to form a coating that is capable of bearing load. Ultimate cure through volume takes place within from 3 to 28 days. For the two-component epoxy resin formulation, which is used both for the conductive top layer 3 and for the conductive priming layer 2, the following composition is preferred (mass fractions based on the mass of the mixture, the sum of the fractions stated necessarily being 100% for all the constituents):

a) 5 to 80% component A (epoxy resin)

b) 0 to 10% accelerators (C4)

c) 0.1 to 4% leveling agents (C10), devolatilizers, defoamers (C11)

d) 0.1 to 5% adhesion promoters, hydrophobicizers (C12)

e) 0 to 30% dyes and pigments (C14)

f) 5 to 70% fillers (C15)

g) 0 to 7% thixotropic agents and thickeners (C16)

h) 0.3 to 30% electrically conductive fillers (C17)

i) 0 to 30% solvents (C18)

j) 1 to 50% component B (epoxy-amine adduct with terminal amino groups)

The floor coatings of the invention are used in particular in production plants in which substances which pose a hazard to water are stored and processed. Such plants include, specifically, chemical plants and also warehouses and plant halls, workshops, power stations, food factories, and EDP rooms in the metal processing industry, pharmaceutical industry, construction industry, authorities or the electronics industry.

The invention is illustrated by the examples below. Parts therein always denote mass fractions. The measured glass transition temperatures (T_{g}) are determined by DSC measurement (second heating, heating rate 20 K/min).

### EXAMPLES

### Example 1

### Epoxy Resin Formulation for an Electrically Conductive Priming Layer 2

The constituents specified below were mixed in a dissolver at room temperature within 30 minutes:

50.0 parts epoxy resin (liquid diepoxy resin based on bisphenol A, specific epoxide group content 5.26 mol/kg)

20.0 parts natural graphite (average particle size 32 to 75 μm)

30.0 parts ethanol

100.0 parts epoxy resin formulation 1 (specific epoxide group content 2.67 mol/kg, “epoxide equivalent”: 374 g/mol)

100 parts of this epoxy resin formulation 1 were admixed immediately prior to application with 31 parts of an adduct hardener having a specific amino group content of 8.7 mol/kg (amine equivalent of 115 g/mol) based on isophoronediamine and the diglycidyl ether of bisphenol A and the mixture was thoroughly homogenized.

### Example 2

### Epoxy Resin Formulation for a Conductive Top Layer 3

The constituents specified below were mixed in a dissolver to form a conductive epoxy resin formulation:

40.0 parts epoxy resin (liquid resin based on bisphenol A, specific epoxide group content 5.26 mol/kg)

20.0 parts hexanedioldiglycidyl ether (reactive diluent)

0.4 part BYK® A 500 (devolatilizer additive)

0.6 part BYK® W 930 (wetting additive)

0.6 part AEROSIL® 300 (finely divided silica)

6.9 parts inorganic pigment RAL 7032

30.0 parts quartz flour W3

1.0 part KRECA CHOP® 103 T (carbon staple fibers having an average length of 3 mm)

100.0 parts epoxy resin formulation 2 (specific epoxide group content 3.42 mol/kg, “epoxide equivalent”: 292 g/mol)

These 100 parts of epoxy resin formulation 2 were admixed immediately prior to application with 40 parts of an adduct hardener based on isophoronediamine and the diglycidyl ether of bisphenol A, having a specific amino group content of 8.7 mol/kg (“amine equivalent” of 115 g/mol), and the mixture obtained was homogenized so that inhomogeneities were no longer visible with the naked eye.

### Example 3

### Application and Testing of the Coatings

The coating formulation for the conductive priming layer 2 from example 1 was rolled onto a 5×5 m² concrete surface 1 blasted in accordance with DIN 28052-1, 2. The mixture from example 1 had a room-temperature pot life of 40 minutes. The coating was dust-dry after 12 hours at room temperature and had cured right through after 24 hours to exhibit, in the cured state, a leakage resistance of from 4 to 100 kohm (extreme values on measurement at 20 different positions). The amount of primer consumed was 0.3 kg/m².

24 hours after the application of the priming layer 2 was at an end the mixture for the top layer 3 (example 2) was applied by using a comb in a layer thickness of from 1.5 to 2 mm.

The mixture from example 2 had a room-temperature pot life of 35 minutes. It was cured right through after one day at room temperature. The T_{g}, measured on a sample applied with the same layer thickness to a glass plate, was approximately 37° C. The leakage resistance of this 2-layer system was less than 10⁶ ohm (measurement at 20 positions on the coating distributed uniformly over the area) and accordingly met the requirements of DIN 53482 and DIN 51953.

We claim:

1. A floor coating, comprising:
an electrically conductive priming layer; and
an electrically conductive top layer disposed on said electrically conductive priming layer, said electrically conductive top layer being impermeable to liquid.

2. A process for producing a floor coating, which comprises:
initially applying a coating formulation of an electrically conductive priming layer to a floor;
subsequently applying a coating formulation of an electrically conductive top layer to the coating formulation of the electrically conductive priming layer, the coating formulation of the electrically conductive top layer being impermeable to liquid; and
curing the electrically conductive priming layer and the electrically conductive top layer to produce the floor coating according to claim 1.

3. The process according to claim 2, which further comprises:
after the curing of the top layer, applying a surface coating formulation of the conductive priming layer;
strewing powdered silicon carbide over the surface coating formulation;
curing the surface coating formulation of the top layer;
removing excess of the powdered silicon carbide by vacuuming; and
sealing the surface coating formulation by rolling the surface coating formulation to produce an antislip layer.

4. The process according to claim 3, which further comprises formulating the surface coating formulation for roller sealing to be electrically conductive.

5. A coating formulation for a floor coating, comprising:
a priming-layer coating formulation for an electrically conductive priming layer;
a top-layer coating formulation for an electrically conductive top layer to be disposed on said electrically conductive priming layer, said electrically conductive top layer being impermeable to liquid; and
epoxy resins in at least one of said priming-layer coating formulation and said top-layer coating formulation.

6. The coating formulation according to claim 5, wherein said epoxy resins include an aqueous epoxy dispersion in said primary-layer coating formulation.

7. The coating formulation according to claim 5, wherein:
at least one of said priming-layer coating formulation and said top-layer coating formulation form a mixture having mass fractions of:
5 to 80% of said epoxy resin,
0 to 10% of at least one accelerator,
0.1 to 4% of at least one of a leveling agent, a devolatilizer, and a defoamer,
0.1 to 5% of at least one of an adhesion promoter and a hydrophobicizer,
0 to 30% of at least one of a dye and a pigment,
5 to 70% of at least one filler,
0 to 7% of at least one of a thixotropic agent and a thickeners,
0.3 to 30% of at least one electrically conductive filler,
0 to 30% of at least one solvent, and
1 to 50% of at least one hardener for said epoxy resin; and
a sum of said mass fractions equaling 100%.

8. The coating formulation according to claim 7, wherein:
said hardener is an epoxide-amine adduct formed from at least one polyamine and at least one epoxide compounds having from 1 to 4 epoxide groups per molecule;
said at least one polyamine being selected from the group of isomers consisting of an aliphatic polyamine and a cycloaliphatic polyamine; and
an amount of said at least one epoxide compound for producing said epoxide-amine adduct being chosen to provide from 1 to 2 mol of said epoxide groups per mole of said polyamine.

9. The coating formulation according to claim 7, wherein said at least one accelerator is selected from the group consisting of benzyl alcohol, salicylic acid, and nonylphenol.

10. The coating formulation according to claim 7, wherein said at least one electrically conductive filler is selected from the group consisting of carbon fibers based on polyacrylonitrile fibers, carbon fibers based on pitch fibers, graphite fibers, graphite, carbon black, and metal powder, and mixtures thereof.

11. The coating formulation according to claim 7, further comprising a resin selected from the group consisting of a hydrocarbon resin, a polyurethane resin, a phenoxy resin, a liquid polymer of butadiene, and a liquid acrylonitrile-butadiene copolymer, and mixtures thereof.

12. The coating formulation according to claim 7, wherein said at least one hardener includes at least one of amine-terminated liquid polymers based on butadiene and amine-terminated liquid acrylonitrile/butadiene copolymers.

13. The coating formulation according to claim 7, wherein said epoxy resin is a liquid diglycidyl ethers based on at least one of bisphenol A and bisphenol F.

14. The coating formulation according to claim 13, further comprising at least one monoepoxide as a reactive diluent in a mass ratio of up to 30% based on a mass of said epoxy resins.

15. A method of protecting a production plant storing substances that are hazardous to water, which comprises applying a floor coating according to claim 1 to a floor of the production plant.

16. A method of protecting buildings, which comprises applying a floor coating according to claim 1 to a floor of the building.

17. The method according to claim 16, which further comprises selecting the building from the group consisting of a chemical plant, a warehouses, a plant hall, a workshop, a power station, a food factory, and an EDP room in a metal processing industry, a pharmaceutical manufacturer, a construction site, an electronics manufacturer.
